(19) United States
(12) Patent Application Publication
(10) Pub. No.: US 2023/0236486 A1
(43) Pub. Date: Jul. 27, 2023

(54) PROJECTION DEVICE

(71) Applicant: Coretronic Corporation, Hsin-Chu (TW)

(72) Inventor: Te-Ying Tsai, Hsin-Chu (TW)

(73) Assignee: Coretronic Corporation, Hsin-Chu (TW)

(21) Appl. No.: 18/155,765

(22) Filed: Jan. 18, 2023

(30) Foreign Application Priority Data
Jan. 26, 2022 (CN) 202210092183.9

(51) Int. Cl. G03B 21/16; G03B 21/14

(52) U.S. Cl. CPC G03B 21/16; G03B 21/145

(57) ABSTRACT

A projection device includes a housing, a spacer plate, and a heat dissipation module. The spacer plate is disposed in the housing to divide the housing into a first space and a second space. The heat dissipation module includes a radiator, a heat dissipation plate, a driving element, and a tube. The radiator is located in the first space, and the heat dissipation plate is located in the second space. The first space has a first air inlet and a first air outlet. A first cooling air flow enters the first space from the first air inlet, flows through the radiator, and is discharged from the first air outlet. The second space has a second air inlet and a second air outlet. A second cooling air flow enters the second space from the second air inlet, and is discharged from the second air outlet.

### CROSS-REFERENCE TO RELATED APPLICATION

This application claims the priority benefit of China application serial no. 202210092183.9, filed on Jan. 26, 2022. The entirety of the above-mentioned patent application is hereby incorporated by reference herein and made a part of this specification.

### BACKGROUND

### Technical Field

The disclosure relates to an optical device, and more particularly, to a projection device.

### Description of Related Art

In a solid-state light source projection system, the heat of the light source is usually dissipated by air cooling. The radiator has the most heat in the solid-state light source projection system, so a fan is required for cooling. If the radiator is placed at the air inlet of the system, the fan is required to be added at the air outlet to help the system discharge hot air. However, such method may increase the usage of the fan and also increase the system noise. If the radiator is placed at the air outlet of the system, the temperature of the incoming air to the radiator will be too high, which will reduce the heat dissipation performance of the radiator. In addition, as the brightness of the solid-state light source projection system increases, the fan required by the system also continues to increase to solve an issue of high-power heat dissipation of the system. However, this also results in higher costs of heat dissipation required for the system and more noise.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device, which has better heat dissipation efficiency.

Other objects and advantages of the disclosure may be further understood from the technical features disclosed herein.

In order to achieve one, a part, or all of the above objectives or other objectives, an embodiment of the disclosure provides a projection device including a housing, a spacer plate, and a heat dissipation module. The spacer plate is disposed in the housing to divide the housing into a first space and a second space. The first space is smaller than the second space. The heat dissipation module includes a radiator, a heat dissipation plate, a driving element, and a tube. The radiator, the heat dissipation plate, and the driving element are connected to one another by the tube to form a loop. The radiator is located in the first space, and the heat dissipation plate is located in the second space. The first space has a first air inlet and a first air outlet, and the radiator is adjacent to the first air inlet and the first air outlet. A first cooling air flow enters the first space from the first air inlet, flows through the radiator, and is discharged from the first air outlet. The second space has a second air inlet and a second air outlet. A second cooling air flow enters the second space from the second air inlet, and is discharged from the second air outlet.

In an embodiment of the disclosure, the projection device further includes a projection lens connected to the housing. The housing has a first side and a second side opposite to each other and a third side and a fourth side opposite to each other. The third side and the fourth side are connected to the first side and the second side, and the projection lens is located on the first side.

In an embodiment of the disclosure, one of the first air inlet and the first air outlet is located on a top of the housing, and the other of the first air inlet and the first air outlet is located on the fourth side. One of the second air inlet and the second air outlet is located on the first side, and the other of the second air inlet and the second air outlet is located on the second side.

In an embodiment of the disclosure, the radiator includes a first radiator and a second radiator. The heat dissipation plate includes a first heat dissipation plate and a second heat dissipation plate. The driving element includes a first driving element and a second driving element. The tube includes a first tube and a second tube. The loop includes a first loop and a second loop. The first radiator, the first heat dissipation plate, and the first driving element are connected to one another by the first tube to form the first loop. The second radiator, the second heat dissipation plate, and the second driving element are connected to one another by the second tube to form the second loop.

In an embodiment of the disclosure, the first space includes a first subspace and a second subspace. The first subspace is located at a corner where the first side and the third side are connected. The second subspace is located at a corner where the second side and the fourth side are connected.

In an embodiment of the disclosure, the first air inlet includes a first sub air inlet and a second sub air inlet. The first air outlet includes a first sub air outlet and a second sub air outlet. One of the first sub air inlet and the first sub air outlet is located on the first side, and the other of the first sub air inlet and the first sub air outlet is located on the third side. One of the second sub air inlet and the second sub air outlet is located on a top of the housing, and the other of the second sub air inlet and the second sub air outlet is located on the fourth side. One of the second air inlet and the second air outlet is located on the first side, and the other of the second air inlet and the second air outlet is located on the second side.

In an embodiment of the disclosure, the radiator includes a first radiator and a second radiator. The heat dissipation plate includes a first heat dissipation plate and a second heat dissipation plate. The driving element includes a first driving element and a second driving element. The tube includes a first tube and a second tube. The loop includes a first loop and a second loop. The first radiator is located in the first subspace, and the second radiator is located in the second subspace. The first radiator, the first heat dissipation plate, and the first driving element are connected to one another by the first tube to form the first loop. The second radiator, the second heat dissipation plate, and the second driving element are connected to one another by the second tube to form the second loop.

In an embodiment of the disclosure, one of the first air inlet and the first air outlet is located on a top of the housing, and the other of the first air inlet and the first air outlet is located on the second side. One of the second air inlet and the second air outlet is located on the first side, and the other of the second air inlet and the second air outlet is located on the second side.

In an embodiment of the disclosure, one of the first air inlet and the first air outlet is located on the fourth side, and the other of the first air inlet and the first air outlet is located on the second side. One of the second air inlet and the second air outlet is located on the first side, and the other of the second air inlet and the second air outlet is located on the second side.

In an embodiment of the disclosure, the first space gradually decreases from the fourth side to the third side to present a trapezoidal space.

In an embodiment of the disclosure, the projection device further includes a system fan disposed in the second space and adjacent to the second side.

In an embodiment of the disclosure, the first space is a rectangular space.

In an embodiment of the disclosure, the heat dissipation module further includes a heat dissipation fan disposed on one side of the radiator and located in the first space.

In an embodiment of the disclosure, the spacer plate has a void. The tube passes through the void to be connected to the radiator located in the first space and the heat dissipation plate and the driving element located in the second space.

In an embodiment of the disclosure, there is a gap between the void and the tube, and a compressible material is filled in the gap.

In an embodiment of the disclosure, the housing includes a cover plate and a base, and the spacer plate is connected to the cover plate and the base.

In an embodiment of the disclosure, the projection device further includes a compressible material having a first side and a second side opposite to each other. One of the first side and the second side is in contact with the spacer plate, and the other of the first side and the second side is in contact with the cover plate or the base.

In an embodiment of the disclosure, an orthographic projection of the first air inlet or the first air outlet on a plane is located between an orthographic projection of the spacer plate on the plane and an orthographic projection of the radiator on the plane.

Based on the above, the embodiments of the disclosure have at least one of the following advantages or effects. In the design of the projection device in the disclosure, the radiator is located in the independent first space. The first cooling air flow enters the first space from the first air inlet, flows through the radiator, and is discharged from the first air outlet. That is to say, the first cooling air flow having the lowest temperature may directly cool the radiator and directly discharge the high-temperature air which has been cooled out of the projection device, so that the high-temperature air does not heat other elements of the projection device. In this way, the heat dissipation efficiency of the projection device in the disclosure may be effectively improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a projection device according to an embodiment of the disclosure.

FIG. 1B is a schematic rear view of the projection device of FIG. 1A.

FIG. 1C is a schematic partial three-dimensional perspective view of the projection device of FIG. 1A.

FIG. 2 is a schematic top view of a projection device according to another embodiment of the disclosure.

FIG. 3 is a schematic top view of a projection device according to another embodiment of the disclosure.

FIG. 4 is a schematic top view of a projection device according to another embodiment of the disclosure.

FIG. 5 is a schematic top view of a projection device according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

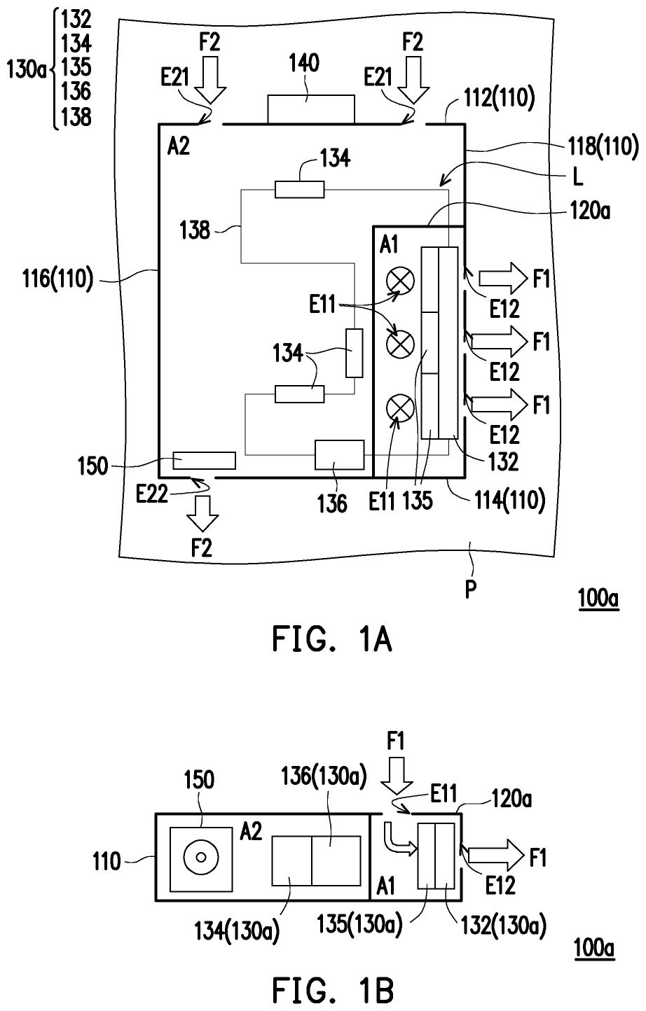

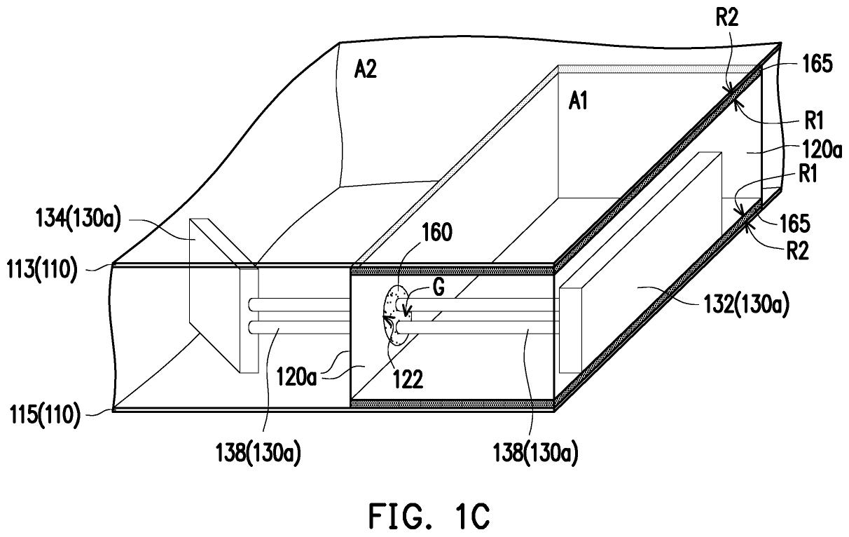

FIG. 1A is a schematic top view of a projection device according to an embodiment of the disclosure. FIG. 1B is a schematic rear view of the projection device of FIG. 1A. FIG. 1C is a schematic partial three-dimensional perspective view of the projection device of FIG. 1A. For convenience of description, some components are omitted in FIG. 1C.

Referring to FIGS. 1A and 1B first, in this embodiment, a projection device 100a includes a housing 110, a spacer plate 120a, and a heat dissipation module 130a. The spacer plate 120a is disposed in the housing 110 to divide the housing 110 into a first space A1 and a second space A2. The first space A1 is smaller than the second space A2, and the first space A1 is, for example, a rectangular space, but the disclosure is not limited thereto. Here, the spacer plate 120a is, for example, a non-metallic material with low heat conductivity or heat insulation, but the disclosure is not limited thereto. The heat dissipation module 130a is configured to dissipate heat from a heating element (not shown) disposed in the housing 110. The heating element is, for example, a light source or a light valve. The light source is, for example, a laser diode (LD), a light emitting diode (LED), other suitable light sources, or a combination thereof, and the light valve is, for example, a digital micromirror device (DMD) in an optical machine, but the disclosure is not limited thereto.

In detail, in this embodiment, the heat dissipation module 130a includes a radiator 132, a heat dissipation plate 134, a driving element 136, and a tube 138. The radiator 132, the heat dissipation plate 134, and the driving element 136 are connected to one another by the tube 138 to form a loop L. In particular, the radiator 132 is located in the first space A1, and the heat dissipation plate 134 and the driving element 136 are located in the second space A2. In other embodiments, the driving element 136 may also be located in the first space A1. In this embodiment and the following descriptions, the driving element 136 is located in the second space A2 as an example for illustration, but the disclosure is not limited thereto. That is to say, the radiator 132 and the heat dissipation plate 134 in this embodiment are located in different spaces. The first space A1 has a first air inlet E11 and a first air outlet E12, and the radiator 132 is adjacent to the first air inlet E11 and the first air outlet E12. A first cooling air flow F1 enters the first space A1 from the first air inlet E11, flows through the radiator 132, and is discharged from the first air outlet E12. The second space A2 has a second air inlet E21 and a second air outlet E22. A second cooling air flow F2 enters the second space A2 from the second air inlet E21, flows through the heat dissipation plate 134, and is discharged from the second air outlet E22. In an embodiment, the second cooling air flow F2 may also be discharged from the second air outlet E22 without flowing through the heat dissipation plate 134.

In this embodiment, the numbers of the second air inlets E21 and the second air outlets E22 are respectively shown as one for illustration, and the numbers of the second air inlets E21 and the second air outlets E22 may be designed in different quantities according to actual conditions. For example, the second air inlet E21 and the second air outlet E22 are respectively more than two, or are designed as two second air inlets E21 and one second air outlet E22.

In order to increase a heat dissipation effect of the radiator 132, the heat dissipation module 130a in this embodiment further includes a heat dissipation fan 135 (in which three are schematically shown) disposed on one side of the radiator 132 and located in the first space A1. In an embodiment that is not shown, the heat dissipation module may also include an accommodating groove. The accommodating groove may be disposed between the radiator and the heat dissipation plate, and connected to the tube to accommodate a working fluid, and the working fluid in the accommodating groove may be circulated in the tube through the driving element. The accommodating groove is, for example, a tank. In this embodiment, the heat dissipation plate 134 is, for example, a cold plate having a heat dissipation fin; the driving element 136 is, for example, a pump, and the heat dissipation module 130a is, for example, a water-cooling heat dissipation module, but the disclosure is not limited thereto.

Furthermore, the projection device 100a in this embodiment further includes a projection lens 140 connected to the housing 110. The projection lens 140 is, for example, a combination including one or more optical lenses having diopters. The optical lens includes, for example, various combinations of non-planar lenses such as biconcave lenses, biconvex lenses, concave-convex lenses, convex-concave lenses, plano-convex lenses, and plano-concave lenses. In detail, the housing 110 has a first side 112 and a second side 114 opposite to each other and a third side 116 and a fourth side 118 opposite to each other. The third side 116 and the fourth side 118 is connected to the first side 112 and the second side 114, and the projection lens 140 is located on the first side 112. As shown in FIG. 1A, one of the first air inlet E11 and the first air outlet E12 is located on a top of the housing 110, and the other of the first air inlet E11 and the first air outlet E12 is located on the fourth side 118. Here, the first air inlet E11 is specifically located on the top of the housing 110, and the first air outlet E12 is specifically located on the fourth side 118 of the housing 110. However, the disclosure is not limited thereto. In particular, an orthographic projection of the first air inlet E11 on a plane P is located between an orthographic projection of one side of the spacer plate 120a on the plane P and an orthographic projection of the radiator 132 on the plane P. Here, the plane P is a reference plane. In another embodiment, when the first air outlet E12 is located on the top of the housing 110, and the first air inlet E11 is located on the fourth side 118 of the housing 110, an orthographic projection of the first air outlet E12 on the plane P is located between the orthographic projection of the one side of the spacer plate 120a on the plane P and the orthographic projection of the radiator 132 on the plane P, which still belongs to the scope of the disclosure.

Referring to FIG. 1A again, one of the second air inlet E21 and the second air outlet E22 is located on the first side 112, and the other of the second air inlet E21 and the second air outlet E22 is located on the second side 114. Here, the second air inlet E21 is specifically located on the first side 112 of the housing 110, and the second air outlet E22 is specifically located on the second side 114 of the housing 110. However, the disclosure is not limited thereto. Here, the second air inlet E21 may be regarded as a system air inlet, and the second air outlet E22 may be regarded as a system air outlet. That is to say, in this embodiment, a position of the first air inlet E11 is different from a position of the second air inlet E21, and a position of the first air outlet E12 is different from a position of the second air outlet E22. That is, the first space A1 is independent of the second space A2.

Since the radiator 132 in this embodiment is located in the independent first space A1, and the first space A1 has the first air inlet E11 and the first air outlet E12 that are independent, in which the low-temperature first cooling air flow F1 enters the first space A1 from on the top of the housing 110, passes through the heat dissipation fan 135, directly cools the radiator 132, and directly discharges a high-temperature air which has been cooled from the first air outlet E12 to an outside of the projection device 100a, the high-temperature air does not heat other elements such as the heat dissipation plate 134 in the second space A2. In this way, the heat dissipation efficiency of the projection device 100a in this embodiment may be effectively improved. In another embodiment, when the heat dissipation fan 135 is closer to the fourth side 118 of the housing 110 relative to the radiator 132, the first cooling air flow F1 may first pass through the radiator 132 and then to the heat dissipation fan 135, which still belongs to the scope of the disclosure.

Further, referring to both FIGS. 1A and 1C, the housing 110 in this embodiment includes a cover plate 113 and a base 115, and the spacer plate 120a is connected to the cover plate 113 and the base 115, thereby separating the housing 110 from the independent first space A1. Furthermore, the spacer plate 120a in this embodiment has a void 122, and the tube 138 may pass through the void 122 to be connected to the radiator 132 in the first space A1, and the heat dissipation plate 134 and the driving element 136 in the second space A2. There is a gap G between the void 122 and the tube 138, and a compressible material 160 may be filled in the gap G. In this way, the first cooling airflow F1 passes through the first space A1 without passing through the second space A2. In addition, the projection device 100a in this embodiment further includes a compressible material 165. The compressible material 165 has a first side R1 and a second side R2 opposite to each other. One of the first side R1 and the second side R2 is in contact with the spacer plate 120a, and the other of the first side R1 and the second side R2 is in contact with the cover plate 113 or the base 115. Here, the first side R1 of the compressible material 165 is specifically in contact with the spacer plate 120a, and the second side R2 of the compressible material 165 is in contact with the cover plate 113 or the base 115. In addition, the projection device 100a in this embodiment further includes a system fan 150 (in which one is schematically shown) disposed in the second space A2 and adjacent to the second side 114 of the housing 110. In an embodiment, the compressible material 160 and the compressible material 165 may use a molded air-tight rubber material.

In brief, in this embodiment, the radiator 132 in the projection device 100a that has the greatest heat dissipation requirement is placed in the independent first space A1, and the first space A1 has the first air inlet E11 and the first air outlet E12 that are independent. The low-temperature first cooling air flow F1 enters the first space A1 from on the top of the housing 110, which may directly cool the radiator 132, and directly discharge the high-temperature air which has been cooled from the first air outlet E12 to the outside of the projection device 100a, so that the high-temperature air does not heat other elements such as the heat dissipation plate 134 in the second space A2. Therefore, the heat dissipation efficiency of the projection device 100 in this embodiment may be improved, and the heat dissipation fan 135 may adopt a lower rotational speed, thereby reducing noise of the heat dissipation fan 135. Compared with the conventional technology, which requires three system fans to dissipate the heat from the system, for the heat dissipation of the remaining components in the system (i.e., the components in the second space A2), the projection device 100a in this embodiment may dissipate the heat only through the one system fan 150, which may effectively reduce the system noise and production costs.

It is noted that some of the reference numerals and descriptions of the above embodiment will apply to the following embodiments. The same reference numerals will represent the same or similar components and the descriptions of the same technical contents will be omitted. Reference may be made to the above embodiment for the omitted descriptions, which will not be repeated in the following embodiments.

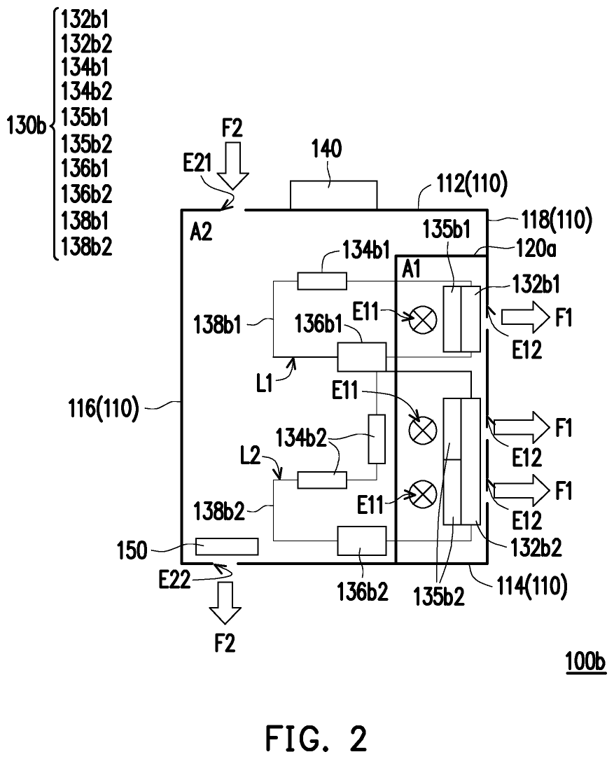

FIG. 2 is a schematic top view of a projection device according to another embodiment of the disclosure. Referring to both FIGS. 1A and 2, a projection device 100b in this embodiment is similar to the projection device 100a in FIG. 1A, and a difference between the two is that a heat dissipation module 130b in this embodiment is different from the heat dissipation module 130a in FIG. 1A. In detail, the heat dissipation module 130b includes a first radiator 132b1, a second radiator 132b2, a first heat dissipation plate 134b1, a second heat dissipation plate 134b2, a first heat dissipation fan 135b1, a second heat dissipation fan 135b2, a first driving element 136b1, a second driving element 136b2, a first tube 138b1, and a second tube 138b2. The first radiator 132b1, the first heat dissipation plate 134b1, and the first driving element 136b1 are connected to one another by the first tube 138b1 to form a first loop L1. The second radiator 132b2, the second heat dissipation plate 134b2, and the second driving element 136b2 are connected to one another by the second tube 138b2 to form a second loop L2.

In brief, the first radiator 132b1 and the second radiator 132b2 in the embodiment are both located in the first space A1, and the first radiator 132b1 and the second radiator 132b2 respectively belong to different loops, so that the first radiator 134b1 and the second radiator 134b2 connected thereto may have a lower cooling water temperature.

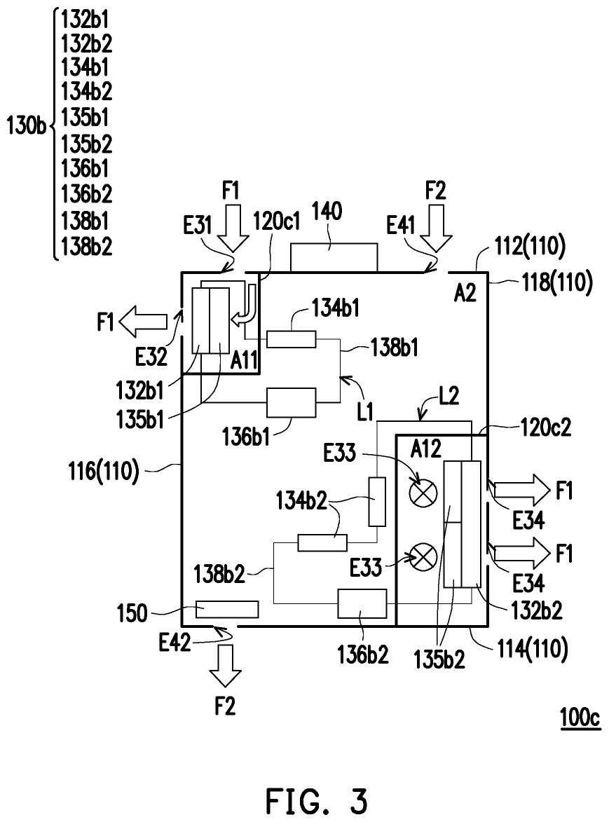

FIG. 3 is a schematic top view of a projection device according to another embodiment of the disclosure. Referring to both FIGS. 2 and 3, a projection device 100c in this embodiment is similar to the projection device 100b in FIG. 2, and a difference between the two is that the first space in this embodiment is different from the first space A1 in FIG. 2. In detail, spacer plates 120c1 and 120c2 are disposed in the housing 110 to divide the housing 110 into a first subspace A11, a second subspace A12, and the second space A2. That is to say, in this embodiment, the first space substantially includes the first subspace A11 and the second subspace A12. The first subspace A11 is located at a corner where the first side 112 and the third side 116 are connected, and the second subspace A12 is located at a corner where the second side 114 and the fourth side 118 are located. The first radiator 132b1 is located in the first subspace A11, and the second radiator 132b2 is located in the second subspace A12. Here, the first subspace A11 and the second subspace A12 are, for example, rectangular spaces, respectively, but the disclosure is not limited thereto.

Referring to FIG. 3 again, the first subspace A11 has a first sub air inlet E31 and a first sub air outlet E32, and the second subspace A12 has a second sub air inlet E33 and a second sub air outlet E34. One of the first sub air inlet E31 and the first sub air outlet E32 is located on the first side 112, and the other of the first sub air inlet E31 and the first sub air outlet E32 is located on the third side 116. Here, the first sub air inlet E31 is specifically located on the first side 112 of the housing 110, and the first sub air outlet E32 is specifically located on the third side 116 of the housing 110. One of the second sub air inlet E33 and the second sub air outlet E34 is located on the top of the housing 110, and the other of the second sub air inlet E33 and the second sub air outlet E34 is located on the fourth side 118. Here, the second sub air inlet E33 is specifically located on the top of the housing 110, and the second sub air outlet E34 is specifically located on the fourth side 118 of the housing 110. One of a second air inlet E41 and a second air outlet E42 is located on the first side 112, and the other of the second air inlet E41 and the second air outlet E42 is located on the second side 114. Here, the second air inlet E41 is specifically located on the first side 112 of the housing 110, and the second air outlet E42 is specifically located on the second side 114 of the housing 110. That is to say, the first sub air inlet E31 and the second air inlet E41 are located on the same side of the housing 110 (i.e., the first side 112).

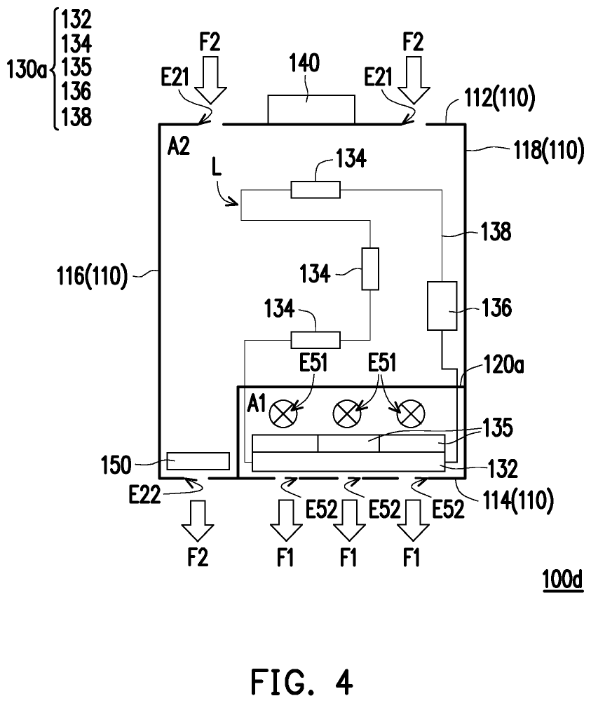

FIG. 4 is a schematic top view of a projection device according to another embodiment of the disclosure. Referring to both FIGS. 1A and 4, a projection device 100d in this embodiment is similar to the projection device 100a in FIG. 1A, and a difference between the two is that in this embodiment, a position of a first air outlet E52 is different from that of the first air outlet E12. In detail, one of a first air inlet E51 and the first air outlet E52 is located on the top of the housing 110, and the other of the first air inlet E51 and the first air outlet E52 is located on the second side 114. Here, the first air inlet E51 is specifically located on the top of the housing 110, and the first air outlet E52 is specifically located on the second side 114 of the housing 110. That is to say, the first air outlet E52 and the second air outlet E22 are both located on the second side 114 of the housing 110.

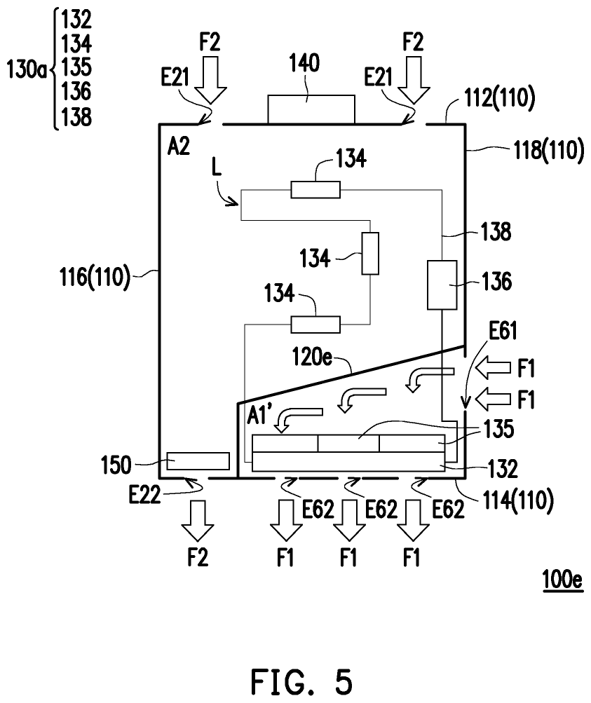

FIG. 5 is a schematic top view of a projection device according to another embodiment of the disclosure. Referring to both FIGS. 1A and 5, a projection device 100e in this embodiment is similar to the projection device 100a in FIG. 1A, and a difference between the two is that in this embodiment, positions of a first air inlet E61 and a first air outlet E62 are different from those of the first air inlet E11 and the first air outlet E12, and a shape of a first space A1′ is also different from that of the first space A1. In detail, in this embodiment, one of the first air inlet E61 and the first air outlet E62 is located on the fourth side 118, and the other of the first air inlet E61 and the first air outlet E62 is located on the second side 114. Here, the first air inlet E61 is specifically located on the fourth side 118 of the housing 110, and the first air outlet E62 is specifically located on the second side 114 of the housing 110. This design may meet the requirements for both splicing and dust prevention of the projection device 100e. The first space A1′ gradually decreases from the fourth side 118 to the third side 116 to present a trapezoidal space, which helps to guide the first cooling air flow F1 to a far end of the radiator 132 farther from the first air inlet E61. In addition, the heat dissipation fan 135 may also be adjusted to different rotational speeds depending on the conditions. For example, the rotational speed of the fan that is farther from the first air inlet E61 is higher, which is helpful to uniformly dissipate the heat from the radiator 132.

Based on the above, the embodiments of the disclosure have at least one of the following advantages or effects. In the design of the projection device in the disclosure, the radiator is located in the independent first space. The first cooling air flow enters the first space from the first air inlet, flows through the radiator, and is discharged from the first air outlet. That is to say, the first cooling air flow having the lowest temperature may directly cool the radiator and directly discharge the high-temperature air which has been cooled out of the projection device, so that the high-temperature air does not heat other elements of the system. In this way, the heat dissipation efficiency of the projection device in the disclosure may be effectively improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising a housing, a spacer plate, and a heat dissipation module, wherein
the spacer plate is disposed in the housing, and the spacer plate is configured to divide the housing into a first space and a second space, wherein the first space is smaller than the second space;
the heat dissipation module comprises a radiator, a heat dissipation plate, a driving element, and a tube, and the radiator, the heat dissipation plate, and the driving element are connected to one another by the tube to form a loop, wherein the radiator is located in the first space, and the heat dissipation plate is located in the second space;
the first space has a first air inlet and a first air outlet, and the radiator is adjacent to the first air inlet and the first air outlet, wherein a first cooling air flow enters the first space from the first air inlet, flows through the radiator, and is discharged from the first air outlet; and
the second space has a second air inlet and a second air outlet, wherein a second cooling air flow enters the second space from the second air inlet, and is discharged from the second air outlet.

2. The projection device according to claim 1, further comprising:
a projection lens connected to the housing, wherein the housing has a first side and a second side opposite to each other and a third side and a fourth side opposite to each other, the third side and the fourth side are connected to the first side and the second side, and the projection lens is located on the first side.

3. The projection device according to claim 2, wherein one of the first air inlet and the first air outlet is located on a top of the housing, and the other of the first air inlet and the first air outlet is located on the fourth side; and
one of the second air inlet and the second air outlet is located on the first side, and the other of the second air inlet and the second air outlet is located on the second side.

4. The projection device according to claim 3, wherein the radiator comprises a first radiator and a second radiator, the heat dissipation plate comprises a first heat dissipation plate and a second heat dissipation plate, the driving element comprises a first driving element and a second driving element, the tube comprises a first tube and a second tube, and the loop comprises a first loop and a second loop;
the first radiator, the first heat dissipation plate, and the first driving element are connected to one another by the first tube to form the first loop; and
the second radiator, the second heat dissipation plate, and the second driving element are connected to one another by the second tube to form the second loop.

5. The projection device according to claim 2, wherein the first space comprises a first subspace and a second subspace, the first subspace is located at a corner where the first side and the third side are connected, and the second subspace is located at a corner where the second side and the fourth side are connected.

6. The projection device according to claim 5, wherein the first air inlet comprises a first sub air inlet and a second sub air inlet, and the first air outlet comprises a first sub air outlet and a second sub air outlet;
one of the first sub air inlet and the first sub air outlet is located on the first side, and the other of the first sub air inlet and the first sub air outlet is located on the third side;
one of the second sub air inlet and the second sub air outlet is located on a top of the housing, and the other of the second sub air inlet and the second sub air outlet is located on the fourth side; and
one of the second air inlet and the second air outlet is located on the first side, and the other of the second air inlet and the second air outlet is located on the second side.

7. The projection device according to claim 6, wherein the radiator comprises a first radiator and a second radiator, the heat dissipation plate comprises a first heat dissipation plate and a second heat dissipation plate, the driving element comprises a first driving element and a second driving element, the tube comprises a first tube and a second tube, and the loop comprises a first loop and a second loop;
the first radiator is located in the first subspace, and the second radiator is located in the second subspace;
the first radiator, the first heat dissipation plate, and the first driving element are connected to one another by the first tube to form the first loop; and
the second radiator, the second heat dissipation plate, and the second driving element are connected to one another by the second tube to form the second loop.

8. The projection device according to claim 2, wherein one of the first air inlet and the first air outlet is located on a top of the housing, and the other of the first air inlet and the first air outlet is located on the second side; and
one of the second air inlet and the second air outlet is located on the first side, and the other of the second air inlet and the second air outlet is located on the second side.

9. The projection device according to claim 2, wherein one of the first air inlet and the first air outlet is located on the fourth side, and the other of the first air inlet and the first air outlet is located on the second side; and
one of the second air inlet and the second air outlet is located on the first side, and the other of the second air inlet and the second air outlet is located on the second side.

10. The projection device according to claim 9, wherein the first space gradually decreases from the fourth side to the third side to present a trapezoidal space.

11. The projection device according to claim 2, further comprising:
a system fan disposed in the second space and adjacent to the second side.

12. The projection device according to claim 1, wherein the first space is a rectangular space.

13. The projection device according to claim 1, wherein the heat dissipation module further comprises a heat dissipation fan disposed on one side of the radiator and located in the first space.

14. The projection device according to claim 1, wherein the spacer plate has a void, and the tube passes through the void to be connected to the radiator located in the first space and the heat dissipation plate and the driving element located in the second space.

15. The projection device according to claim 14, wherein there is a gap between the void and the tube, and a compressible material is filled in the gap.

16. The projection device according to claim 1, wherein the housing comprises a cover plate and a base, and the spacer plate is connected to the cover plate and the base.

17. The projection device according to claim 16, further comprising:
a compressible material having a first side and a second side opposite to each other, wherein one of the first side and the second side is in contact with the spacer plate, and the other of the first side and the second side is in contact with the cover plate or the base.

18. The projection device according to claim 1, wherein an orthographic projection of the first air inlet or the first air outlet on a plane is located between an orthographic projection of the spacer plate on the plane and an orthographic projection of the radiator on the plane.
